(19) United States
(12) Patent Application Publication
(10) Pub. No.: US 2023/0096583 A1
(43) Pub. Date: Mar. 30, 2023

(54) HEALTH DRINK CONTAINING WATER-SOLUBLE NUCLEOPROTEIN

(71) Applicant: FORDAYS CO., LTD, Tokyo (JP)

(72) Inventors: Keita SUTOH, Tokyo (JP); Mika FUJITA, Tokyo (JP)

(73) Assignee: FORDAYS CO., LTD, Tokyo (JP)

(21) Appl. No.: 17/911,021

(22) PCT Filed: Mar. 10, 2021
(86) PCT No.: PCT/JP2021/009643

§ 371 Date: Sep. 12, 2022

(30) Foreign Application Priority Data
Mar. 12, 2020 (JP) 2020-043068
Jan. 14, 2021 (JP) 2021-004423

(51) Int. Cl. A23L 2/38; A23L 2/66; A23L 2/60; A23L 2/02

(52) U.S. Cl. CPC A23L 2/38; A23L 2/66; A23L 2/60; A23L 2/02

(57) ABSTRACT

To provide a health drink containing a water-soluble nucleoprotein. A health drink containing a water-soluble nucleoprotein as an active component, and including a composition for elevating a score of a CD4/CD8 cell ratio, a composition for elevating a score of a naive/memory T cell ratio, a composition for elevating a score of the number of NK cells, a composition for decreasing a concentration of 8-OHdG, a composition for enlarging a particle diameter of LDL in a small dense LDL fraction, a composition for elevating a concentration of HDL-C, a composition for elevating a concentration of hemoglobin, or a composition for increasing a rate of hematocrit.

### TECHNICAL FIELD

The present invention relates to a health drink containing a water-soluble nucleoprotein, and more specifically to a health drink containing a water-soluble nucleoprotein as an active component and having an action mechanism useful for health.

### BACKGROUND ART

Some health drinks containing a water-soluble nucleoprotein have been described.

For example, Japanese Unexamined Patent Application, Publication No. 2004-016143 (Patent Document 1) discloses a method for producing a water-soluble nucleoprotein; Japanese Unexamined Patent Application, Publication No. 2003-325149 (Patent Document 2) discloses a health drink including a water-soluble nucleoprotein; International Publication WO 2006/070453 (Patent Document 3) discloses a health drink including a water-soluble nucleoprotein, and having more enhanced effects of maintaining and promoting human health as compared with conventional health drinks; and International Publication WO 2013/054525 (Patent Document 4) discloses that a health drink including a water-soluble nucleoprotein, oligo RNA, zinc, collagen, chondroitin, hyaluronic acid, vitamins, and glutathione has activities such as increasing a concentration of blood dehydroepiandrosterone sulfate (DHEA-S), promoting expression of an olfactory receptor gene, and suppressing expression of a TNFRSF10C gene or a TNFSF14 gene.

Furthermore, there is a description that a water-soluble nucleoprotein (hydrolyzed salmon milt extract) strengthens object recognition and position memory through an increase in a cytidine nucleoside level in the hippocampus of normal mice (see non-Patent Document 1).

### CITATION LIST

Patent Document
Patent Document 1: Japanese Unexamined Patent Application, Publication No. 2004-016143
Patent Document 2: Japanese Unexamined Patent Application, Publication No.
Patent Document 3: International Publication WO2006/070453
Patent Document 4: International Publication WO2013/054525

### Non-Patent Document

Non-Patent Document 1: J Med Food, 22(4), 2019, p. 408-415

### SUMMARY OF THE INVENTION

### Technical Problems

The present invention has an object to provide a health drink containing a water-soluble nucleoprotein as an active component and having an action mechanism useful for health.

### Solution to Problem

In order to solve the above-mentioned problems, the present inventors have conducted intensive studies. As a result, the present inventors have found a health drink containing a water-soluble nucleoprotein as an active component and having action mechanisms useful for health, such as an elevation of a score of a CD4/CD8 cell ratio, an elevation of a score of a naive/memory T cell ratio, and an elevation of a score of the number of NK cells, for improving immune function; a decrease in a concentration of 8-OHdG for reducing oxidative stress; enlargement of a particle diameter of LDL in a small dense LDL fraction, and an elevation of a concentration of HDL-C, for improving lipid metabolism function; an elevation of a concentration of hemoglobin, and an increase in a rate of hematocrit, for improving anemia, and the present inventors have completed the present invention.

In other words, the present invention relates to:

[1] a health drink containing a water-soluble nucleoprotein as an active component, and including a composition for elevating a score of the CD4/CD8 cell ratio;
[2] a health drink containing a water-soluble nucleoprotein as an active component, and including a composition for elevating a score of a naive/memory T cell ratio;
[3] a health drink containing a water-soluble nucleoprotein as an active component, and including a composition for elevating a score of a number of NK cells;
[4] a health drink containing a water-soluble nucleoprotein as an active component, and including a composition for decreasing a concentration of 8-OHdG;
[5] a health drink containing a water-soluble nucleoprotein as an active component, and including a composition for enlarging a particle diameter of LDL in a small dense LDL fraction;
[6] a health drink containing a water-soluble nucleoprotein as an active component, and including a composition for elevating a concentration of HDL-C;
[7] a health drink containing a water-soluble nucleoprotein as an active component, and including a composition for elevating a concentration of hemoglobin; and
[8] a health drink containing a water-soluble nucleoprotein as an active component, and including a composition for increasing a rate of hematocrit.

### Advantageous Effect of Invention

The present invention provides a health drink that can exhibit action mechanisms useful for health, such as an elevation of a score of a CD4/CD8 cell ratio, an elevation of a score of a naive/memory T cell ratio, an elevation of a score of the number of NK cells, decrease in a concentration of 8-OHdG, enlargement of a particle diameter of LDL in a small dense LDL fraction, an elevation of a concentration of HDL-C, an elevation of a concentration of hemoglobin, and an increase in a rate of hematocrit.

### DESCRIPTION OF EMBODIMENTS

The present invention will be described in more details.

A health drink of the present invention contains a water-soluble nucleoprotein as an active component.

The water-soluble nucleoprotein that can be used in the health drink of the present invention is not particularly limited as long as it is a water-soluble nucleoprotein obtained by extracting nucleic acid from a biological cell and enzymatically treating thereof so as to reduce a molecular weight thereof. Examples for the water-soluble nucleoprotein include a water-soluble nucleoprotein obtained by subjecting milt of fish to enzymatic treatment so as to reduce a molecular weight and to make water-soluble.

The term “water-soluble” as used herein means a property capable of being dissolved in water at a concentration of 0.1% by mass or more.

Examples for the fish milt include milt of salmon, trout, herring, and the like. The salmon milt is preferable.

Examples for the enzymatic treatment of fish milt include a method of crushing milt of fish to obtain a suspension, and then treating the obtained suspension with protease, and then with nuclease.

Usually, DNA extracted from milt has a molecular weight of 1 million or more, but the molecular weight is reduced by enzymatic treatment. A preferable water-soluble nucleoprotein includes preferably 20% by mass or more, and more preferably 30% by mass or more of nucleoside/nucleotide/oligonucleotide/polynucleotide having a molecular weight of 250 to 100000, preferably 500 to 13200, or 250 to 6600.

Further preferably, a water-soluble nucleoprotein includes 2% by mass or more of nucleoside/nucleotide/oligonucleotide/polynucleotide having a molecular weight of 500 to 13200, and 18% by mass or more of the above having a molecular weight of 250 to 6600.

The health drink of the present invention includes 3 g to 20 g, preferably 3 g to 15 g, more preferably 4 g to 10 g, and further preferably 4 g to 7 g of a water-soluble nucleoprotein, for example, as a DNA-containing salmon milt extract, per 720 mL of the health drink.

The health drink of the present invention can also include RNA as a component other than the water-soluble nucleoprotein.

The above-mentioned RNA is not particularly limited as long as it is low-molecular weight RNA obtained by reducing the molecular weight of ribonucleic acid (RNA). Specifically, suitable examples include RNA obtained by extracting and purifying RNA from well-known yeast such as beer yeast, torula yeast, milk yeast, and baker's yeast, and reducing the molecular weight of the RNA, so that the RNA contains 20 to 50% of a fraction having a molecular weight of 1000 to 33000, and a fraction having a molecular weight of 1000 or less in a larger rate that is more than that of the molecular weight of 1000 to 33000, for example, a rate of 30 to 50%.

Examples of the method for producing and obtaining the above RNA include well-known methods such as a method of subjecting the RNA isolated, extracted, and purified from the above yeast to enzyme decomposition treatment or hydrolysis treatment so as to reduce the molecular weight thereof; a method of chemically or enzymatically synthesizing the RNA; and a method of purchasing a commercial product of RNA. Specifically, a method of preparing RNA by hydrolyzing a 3′,5′-phosphodiester bond of RNA using a heat stable nuclease (see, for example, Japanese Unexamined Patent Application, Publication No. 2007-23024) is suitable.

Specific examples for RNA that can be added to the health drink of the present invention include an RNA-containing edible yeast, and the like.

When the health drink of the present invention contains RNA, the addition amount of RNA, for example, as an RNA-containing edible yeast extract, is in the range of 500 mg to 2000 mg, and preferably 600 mg to 1500 mg per 720 mL of the health drink.

The health drink of the present invention can also include collagen as a component other than the water-soluble nucleoprotein.

The above collagen includes fibrous proteins having a structure of repeating units of a peptide fragment of “-glycine-amino acid-amino acid-” and constituting an extracellular matrix in tissues such as skin tissue, cartilage tissue, bone tissue, blood vessel tissue, organs, and tendons; and hydrolyzate thereof (collagen peptide), as well as derivatives thereof. Examples for the collagen derivative include atelo products, acylated products, succinylated products, and the like, of collagen and hydrolyzate thereof. It is common to use a water-soluble collagen hydrolyzate (collagen peptide) because the typical collagen has a molecular weight of about several tens of thousands to 300000 and is usually water-insoluble.

Examples of the method for producing and obtaining a collagen hydrolyzate include well-known methods such as a method of washing the dermis and crushing the bone of an animal such as pig or cow, then carrying out pretreatment required according to collagen-containing tissues, such as alkali treatment, neutralization, degreasing, or mineral removal to obtain an extract, then decomposing, filtering and then sterilizing, and spray-drying and then powdering the extract. In addition to this method, commercial products can also be used.

Specific examples for the collagen that can be added to the health drink of the present invention include porcine collagen peptide, fish collagen peptide (including gelatin), collagen-containing mineral complexes, and the like.

The above collagens may be used alone or as a mixture of two or more types of the collagens.

When the health drink of the present invention contains collagen, the addition amount of collagen is in the range of 30 g to 150 g, preferably 50 g to 100 g, and more preferably 60 g to 80 g per 720 mL of the health drink.

The health drink of the present invention can also include chondroitin as a component other than the water-soluble nucleoprotein.

The above chondroitin includes chondroitins including chondroitin, which is a kind of glycosaminoglycan (mucopolysaccharide) and has a basic structure in which sulfuric acid is bonded to a saccharide chain including two sugars, that is, D-glucuronic acid (GlcA) and N-acetyl-D-galactosamine (GalNAc), derivatives thereof or salts thereof. Examples for the chondroitin include chondroitin-4-sulfate (chondroitin sulfate A), dermatan sulfate (chondroitin sulfate B), chondroitin-6-sulfate (chondroitin sulfate C), chondroitin sulfate D, chondroitin-4,6-sulfate (chondroitin sulfate E), and the like; examples for the chondroitin derivative include condensates of chondroitin and a reducing sugar such as glucose, galactose, maltose, lactose, and the like, derivatives such as aryl ester, phosphoester, and sulfate ester; examples for the salt of chondroitin and derivatives thereof include alkali metal salts such as sodium salt and potassium salt, inorganic salts such as hydrochloride, sulfate, and ammonium salt, organic salts such as lactate, acetate, and triethanolamine salt.

Examples of the method for producing and obtaining the chondroitins include well-known methods such as a method of isolating and extracting chondroitin from chondroitin-containing natural products such as a shark cartilage, shark fin extract; a method of chemically or enzymatically synthesizing chondroitin; and a method of purchasing commercial products. Suitable examples for the commercial product include chondroitin-containing mucopolysaccharide protein complexes, for example, “Shark cartilage extract (70)” (manufactured by NAKAHARA CO., LTD.).

When the health drink of the present invention contains chondroitin, the addition amount of chondroitin is in the range of 50 mg to 250 mg, preferably 100 mg to 200 mg, and more preferably 120 mg to 200 mg per 720 mL of the health drink.

The health drink of the present invention can also include hyaluronic acid as a component other than the water-soluble nucleoprotein.

Examples for the above hyaluronic acid include hyaluronic acids including hyaluronic acid, which is a kind of proteoglycan and has a basic structure of linking disaccharide units in which the first position of β-D-glucuronic acid and the third position of β-D-N-acetyl-glucosamine are bonded, derivatives thereof and salts thereof; and low molecular-weight hyaluronic acid or hyaluronic acid decomposition products obtained by subjecting such hyaluronic acids to enzymatic treatment with, for example, hyaluronidase, or to heating and pressurizing treatment. Examples for the above hyaluronic acid derivative include acetylated hyaluronic acid (see Japanese Unexamined Patent Application, Publication No. H8-53501), sulfated hyaluronic acid (see Japanese Unexamined Patent Application, Publication No. H10-195107), hyaluronic acid substituted with a bioorganic acid such as lactic acid (see Japanese Unexamined Patent Application, Publication No. H6-16702), and crosslinked hyaluronic acid (see Japanese Unexamined Patent Application, Publication No. H7-97401); examples for the salt of the hyaluronic acid and the derivatives thereof include metal salts such as sodium salt, potassium salt, lithium salt, magnesium salt, and calcium salt; basic amino acid salts such as lysine salt, arginine salt, and histidine salt; ammonium salt; triethanolamine salt, diisopropanolamine salt, and the like.

Examples of the method for producing and obtaining hyaluronic acids include well-known methods such as a method of isolating and extracting hyaluronic acids from a cockscomb, mammal umbilical cord, metabolites of fish or bacteria belonging to genus Lactobacillus or Streptococcus; a method of chemically or enzymatically synthesizing hyaluronic acids; and a method of purchasing a commercial product.

Specific examples for hyaluronic acid to be added to the health drink of the present invention is a cockscomb extract and the like.

When the health drink of the present invention contains hyaluronic acid, the addition amount of hyaluronic acid is in the range of 10 mg to 150 mg, preferably in the range of 30 mg to 100 mg, and more preferably 40 mg to 80 mg per 720 mL of the health drink.

The health drink of the present invention can also include zinc as a component other than the water-soluble nucleoprotein.

The above zinc is not particularly limited as long as it can be added in a form usable for foods, and can be administered in a form such as zinc gluconate, zinc sulfate, or edible zinc yeast. Zinc is preferably added as an edible zinc-containing yeast by which an absorption rate into the body is supposed to become higher. It is desirable to use yeast containing 2% by mass, preferably 3% by mass, more preferably 4% by mass or more of zinc. Examples for the commercial product include edible yeasts (containing zinc) such as zinc yeast (manufactured by Grow Company, Inc.), mineral yeast—Zn (manufactured by Oriental Yeast Co., Ltd.), and zinc yeast (manufactured by Bio Springer). Among them, zinc yeast (manufactured by Grow Company, Inc.) is suitable.

When the health drink of the present invention contains zinc, the addition amount of zinc is in the range of 100 mg to 1500 mg, preferably 150 mg to 1500 mg, and more preferably 200 mg to 800 mg per 720 mL of the health drink.

The health drink of the present invention can also include vitamins other than the water-soluble nucleoprotein.

The above vitamins are not particularly limited as long as they are vitamins, derivatives thereof, or salts thereof, which can exhibit the effects of the present invention mentioned above. Examples therefor include vitamin C (ascorbic acid), vitamin B1 (thiamine), vitamin B2 (riboflavin), vitamin B6 (pyridoxine), vitamin B12 (cobalamin), folic acid (vitamin B9), niacin (vitamin B3), calcium pantothenate, and the like. Examples for the derivative or salt of vitamin C include calcium ascorbate and sodium ascorbate; examples for the derivative or salt of vitamin B1 include thiamin hydrochloride, thiamine nitrate, bisthiamine nitrate, thiamine dicetylsulfate, fursultiamine hydrochloride, octotiamine, benfotiamine, and the like; examples for the derivative or salt of vitamin B2 include riboflavin tetrabutyrate, and riboflavin sodium phosphate; examples for the derivative or salt of vitamin B6 include pyridoxine hydrochloride, pyridoxalisol (pyridoxal phosphate), and pyridoxamine; examples for the derivative or salt of vitamin B12 include cyanocobalamin, hydroxocobalamin, hydroxocobalamin acetate, hydroxocobalamin hydrochloride, methylcobalamin, and adenosylcobalamin. Preferably 5 or more, more preferably 6 or more, and further preferably 7 or more, of the above vitamins are included. Specifically, examples for the preferable combination of vitamins include all of vitamin C, vitamin B1, vitamin B2, vitamin B6, vitamin B12, folic acid, niacin, and calcium pantothenate.

When the health drink of the present invention includes eight kinds of vitamins as mentioned above, the addition amount of vitamin C is in the range of 1500 mg to 7000 mg, preferably 2000 mg to 7000 mg, and more preferably 3000 mg to 6000 mg per 720 mL of the health drink; the addition amount of vitamin B1 is in the range of 5 mg to 50 mg, preferably 10 mg to 40 mg, and more preferably 10 mg to 30 mg per 720 mL of the health drink; the addition amount of vitamin B2 is in the range of 5 mg to 50 mg, preferably 10 mg to 50 mg, and more preferably 14 mg to 40 mg per 720 mL of the health drink; the addition amount of vitamin B6 is in the range of 5 mg to 50 mg, preferably 10 mg to 50 mg, and more preferably 15 mg to 45 mg per 720 mL of the health drink; the addition amount of vitamin B12 is in the range of 10 mg to 70 mg, preferably 20 mg to 70 mg, and more preferably 25 mg to 65 mg per 720 mL of the health drink; the addition amount of folic acid is in the range of 1 to 8 mg, preferably 1 to 7 mg, and more preferably 2.5 to 6.5 mg per 720 mL of the health drink; the addition amount of niacin is in the range of 50 mg to 500 mg, preferably 100 mg to 400 mg, and more preferably 120 mg to 350 mg per 720 mL of the health drink; the addition amount of calcium pantothenate is in the range of 30 mg to 300 mg, preferably 50 mg to 250 mg, and more preferably 50 mg to 200 mg per 720 mL of the health drink.

The health drink of the present invention can also include other components other than the components mentioned above as a water-soluble nucleoprotein.

The above other components include sweeteners such as fructose glucose liquid sugar, refined white sugar, syrup containing rare sugar, erythritol, and sucralose, fruit juices such as pineapple juice, preservatives such as sodium benzoate, colorants such as caramel pigments, emulsifiers (for example, derived from soybean), perfumes, acidifiers, and the like. When the health drink of the present invention contains these other components, an appropriate amount of each component can be added.

The health drink of the present invention has action mechanisms useful for health, such as an elevation of a score of the CD4/CD8 cell ratio, an elevation of a score of the naive/memory T cell ratio, an elevation of a score of the number of NK cells, a decrease in a concentration of 8-OHdG, enlargement of a particle diameter of LDL in a small dense LDL fraction, an elevation of a concentration of HDL-C, and an elevation of a concentration of hemoglobin, and an increase in a rate of hematocrit.

In the above action mechanisms, all of the elevation of the score of the CD4/CD8 cell ratio, the elevation of the score of the naive/memory T cell ratio, and the elevation of a score of the number NK cells are thought to contribute to improvement in immune function.

The 8-OHdG is an indicator that reflects the degree of oxidative damage to DNA in living organisms. Therefore, a decrease in the concentration of 8-OHdG is thought to reduce the degree of oxidative genetic damage.

Furthermore, enlargement of a particle diameter of LDL in a small dense LDL fraction is thought to contribute to health for the following reasons.

As compared with ordinary large LDL, the small particle LDL is not easily metabolized in the liver and resides in blood for longer time because the small particle LDL has less affinity to an LDL receptor; small LDL particles are easily bonded to polysaccharide; small LDL particles easily enter the vessel wall because they are small particles; small LDL particles are susceptible to oxidative denaturation due to little antioxidants against oxidative stress, are called “super bad cholesterol”, and are a risk factor for atherosclerosis.

Therefore, the enlargement of the particle diameter of LDL in a small dense LDL fraction is thought to reduce the risk of occurrence of atherosclerosis. Furthermore, since there is a description that the particle diameter of LDL becomes smaller mainly when the value of triglyceride (TG) is high, it is suggested that the enlargement of the particle diameter in a small particle LDL may activate lipid metabolism.

HDL-C is responsible for eliminating excess cholesterol and is also called good cholesterol. Therefore, it is thought that the elevation of the concentration of HDL-C reduces the risk of occurrence of arteriosclerosis.

Hemoglobin and hematocrit are indicators of anemia, and the like. Therefore, an elevation of the concentration of hemoglobin and an increase in the rate of hematocrit may contribute to improvement of anemia.

### EXAMPLES

### Example 1

The components shown in Table 1 were dissolved in water to prepare 720 mL of health drink. The obtained health drink was subjected to the following evaluations.

TABLE 1
Components included in health drink

| Raw material | Amount per 720 mL of drink | |
|---|---|---|
| Water-soluble nucleoprotein | 4320 | mg |
| RNA-containing edible yeast | 1200 | mg |
| Collagen | 75 | g |
| Chondroitin | 164 | mg |
| Hyaluronic acid | 64.8 | mg |
| Zinc | 36 | mg |
| Folic acid | 2.88 | mg |
| Niacin | 144 | mg |
| Vitamin C | 3600 | mg |
| Vitamin B1 | 13.68 | mg |
| Vitamin B2 | 14.4 | mg |
| Vitamin B6 | 15.84 | mg |
| Vitamin B12 | 25.92 | mg |
| Calcium pantothenate | 79.2 | mg |

| | |
|---|---|
| Other additive components (fructose | Appropriate amount |
| glucose liquid sugar/syrup containing | |
| rare sugar/erythritol/pineapple juice/ | |

<Subjects>

Healthy men and women in their 20s to 60s who do not need medication.

Number of test subject: 18 (men: 12, women: 6)

<Test Method>

According to the standard intake of test food, subject persons were allowed to take 60 mL per day of the health drink shown in Table 1. In principle, the subject persons were instructed to take the health drink twice a day in the morning and evening. In the case of forgetting to take the health drink or being unable to take the health drink at the time indicated, a subject person was allowed to take 60 mL per day in total. Before intake, on week 4 after intake, and on week 8 after intake, blood collection (blood collection volume: 21 mL per collection), urine collection (urine collection volume: 10 mL per collection), inquiry, anthropometry (height, weight, and BMI), and blood pressure measurement (using an automatic measuring device) were performed.

<Evaluation Items and Evaluation Method>

A score of the number of T-cells, a score of the T cell growth coefficient, a score of the CD4/CD8 cell ratio, a score of the number of naive T cells, a score of the number of naive/memory T cells, a score of the number of B cells, a score of the number of NK cells, and a score of the number of CD8+CD28+T cells.

Each measurement value was obtained from blood and scored based on database. 8-OHdG

The amount of 8-OHdG in urine was measured.

Particle diameter of small particle LDL

Small particle LDL sub-fractions were categorized by electrophoresis, and small particle LDL having a particle diameter of 25.5 nm or less was checked.

HDL-C

HDL-C was determined by a biochemical test.

Hemoglobin (Hg) and hematocrit (Ht)

Hemoglobin (Hg) and hematocrit (Ht) were determined by a hematologic test.

<Evaluation Results>

Table 2 shows the score of the number of T-cells, the score of the T cell growth coefficient, the score of the CD4/CD8 cell ratio, the score of the number of naive T cells, the score of the number of naive/memory T cells, the score of the number of B cells, the score of the number of NK cells, and the score of the number of CD8+CD28+T cells before intake, on week 4 after intake, and on week 8 after intake of the health drink shown in Table 1.

TABLE 2

| | Score before | Score: 4 weeks | Score: 8 weeks |
|---|---|---|---|
| Evaluation item | intake | after intake | after intake |
| Number of T-cells | 2.50 ± 0.51 | 2.50 ± 0.51 | 2.50 ± 0.51 |
| T cell growth | 2.89 ± 0.32 | 2.72 ± 0.46 | 2.94 ± 0.24 |
| coefficient | | | |
| CD4/CD8 cell ratio | 2.11 ± 0.90 | 1.94 ± 0.94 | 2.22 ± 0.81 ^{t} |
| Number of naive | 2.39 ± 0.61 | 2.39 ± 0.70 | 2.39 ± 0.57 |
| T cells | | | |
| Naive/memory | 1.61 ± 0.50 | 1.78 ± 0.55 ^{t} | 1.78 ± 0.43 ^{t} |
| T cell ratio | | | |
| Number of B cells | 3.00 ± 0.00 | 3.00 ± 0.00 | 3.00 ± 0.00 |
| Number of NK | 2.17 ± 0.38 | 2.11 ± 0.47 | 2.33 ± 0.49 ^{t} |
| cells | | | |
| Number of CD8 + | 2.44 ± 0.51 | 2.44 ± 0.51 | 2.44 ± 0.51 |
| CD28 + T cells | | | |

^{t} p < 0.1, t-test, average value ± SD

With the intake of the health drink shown in Table 1, the score of the CD4/CD8 cell ratio, the score of the ratio of naive/memory T cells, and the score of the number of NK cells showed an improvement tendency (significance level of 10% (p<0.1)).

Table 3 shows the concentration of 8-OHdG (ng/mg·C) in urine before intake, on week 4 after intake, and on week 8 after intake of the health drink shown in Table 1.

TABLE 3

| Evaluation | | Before | 4 weeks after | 8 weeks after |
|---|---|---|---|---|
| item | Unit | intake | intake | intake |
| 8-OHdG (urine) | ng/mg · C. | 7.06 ± 2.1 | 6.8 ± 1.68 | 6.43 ± 1.8 ^{t} |

^{t} p < 0.1, t-test, average value ± SD

With the intake of the health drink shown in Table 1, the concentration of 8-OHdG in urine showed a decrease tendency (significance level: 10% (p<0.1)).

Table 4 shows the particle diameter (nm) of LDL in a small dense LDL fraction before intake, on week 4 after intake, and on week 8 after intake of the health drink shown in Table 1.

TABLE 4

| Evaluation | | Before | 4 weeks after | 8 weeks after |
|---|---|---|---|---|
| item | Unit | intake | intake | intake |
| Particle | nm | 26.71 ± 0.576 | 26.65 ± 0.614 | 26.89 ± 0.570 * |
| diameter of | | | | |
| small parti- | | | | |
| cle LDL | | | | |

* p < 0.05, Wilcoxon signed rank test, average value ± SD

With the intake of the health drink shown in Table 1, the particle diameter of LDL (nm) in the small dense LDL fraction was enlarged significantly (p<0.05).

Table 5 shows the concentration (mg/dL) of HDL-C before intake, on week 4 after intake, and on week 8 after intake of the health drink shown in Table 1.

TABLE 5

| Evaluation | | Before | 4 weeks after | 8 weeks after |
|---|---|---|---|---|
| item | Unit | intake | intake | intake |
| HDL-C | mg/dL | 59.60 ± 12.10 | 60.27 ± 12.48 | 63.40 ± 12.40 ** |

** p < 0.01, t-test, average value ± SD

With the intake of the health drink shown in Table 1, the concentration (mg/dL) of HDL-C was elevated significantly (p<0.01).

Table 6 shows the concentration (g/dL) of hemoglobin (Hg) and the rate (%) of hematocrit (Ht) before intake, on week 4 after intake, and on week 8 after intake of the health drink shown in Table 1.

TABLE 6

| Evaluation | | Before | 4 weeks after | 8 weeks after |
|---|---|---|---|---|
| item | Unit | intake | intake | intake |
| Hg | g/dL | 14.44 ± 1.22 | 14.36 ± 1.21 | 14.64 ± 1.09 ^{t} |
| Ht | % | 45.54 ± 3.28 | 45.71 ± 2.99 | 46.24 ± 2.98 * |

^{t} p < 0.1,
* p < 0.05, t-test, average value ± SD

With the intake of the health drink shown in Table 1, the concentration (g/dL) of hemoglobin (Hg) showed an elevation tendency (significance level: 10% (p<0.1)), and the rate (%) of hematocrit (Ht) increased significantly (p<0.05).

1. A health drink containing a water-soluble nucleoprotein as an active component, and comprising a composition for elevating a score of a CD4/CD8 cell ratio.

2. A health drink containing a water-soluble nucleoprotein as an active component, and comprising a composition for elevating a score of a naive/memory T cell ratio.

3. A health drink containing a water-soluble nucleoprotein as an active component, and comprising a composition for elevating a score of a number of NK cells.

4. A health drink containing a water-soluble nucleoprotein as an active component, and comprising a composition for decreasing a concentration of 8-OHdG.

5. A health drink containing a water-soluble nucleoprotein as an active component, and comprising a composition for enlarging a particle diameter of LDL in a small dense LDL fraction.

6. A health drink containing a water-soluble nucleoprotein as an active component, and comprising a composition for elevating a concentration of HDL-C.

7. A health drink containing a water-soluble nucleoprotein as an active component, and comprising a composition for elevating a concentration of hemoglobin.

8. A health drink containing a water-soluble nucleoprotein as an active component, and comprising a composition for increasing a rate of hematocrit.

9. A health drink, comprising:
a water-soluble nucleoprotein as an active component, wherein said health drink provides one or more of the following action mechanisms useful for health; elevating a score of a CD4/CD8 cell ratio, elevating a score of a naive/memory T cell ratio, elevating a score of a number of NK cells, decreasing a concentration of 8-OhdG, enlarging a particle diameter of LDL in a small dense LDL fraction, elevating a concentration of HDL-C, elevating a concentration of hemoglobin and increasing a rate of hematocrit.

10. The health drink of claim 9, wherein said nucleoprotein is provided from comprises milt of fish that has been subjected to enzymatic treatment to reduce the molecular weight thereof.

11. The health drink of claim 10, wherein said fish is salmon.

12. A method for improving health comprising:
drinking an effective amount of the health drink of claim 9.

13. The method of claim 12, wherein the health drink comprises.

14. The method of claim 12, wherein said health drink further comprises at least one of a sweetener, a fruit juice, a preservative, a colorant, an emulsifier, a perfume, an acidifier.

15. The method of claim 12, wherein said drinking is performed by a human.
